(19) United States
(12) Patent Application Publication
(10) Pub. No.: US 2012/0197727 A1
(43) Pub. Date: Aug. 2, 2012

(54) APPARATUS AND METHOD FOR PROVIDING APPLICATION HAVING EMBEDDED ADVERTISEMENT INFORMATION

(75) Inventor: Dong Kyun KIM, Seoul (KR)

(73) Assignee: PANTECH CO., LTD., Seoul (KR)

(21) Appl. No.: 13/247,756

(22) Filed: Sep. 28, 2011

(30) Foreign Application Priority Data
Jan. 31, 2011 (KR) 10-2011-0009384

(51) Int. Cl. G06Q 30/00

(52) U.S. Cl. 705/14.64

(57) ABSTRACT

An apparatus and a method for providing an application having embedded advertisement information, in which an application having embedded advertisement information may be transmitted and received between a server which transmits the application and a terminal which receives the application. The apparatus includes a receiving unit to receive an application and advertisement information added to an execution file of the application from an application providing server, a control unit to execute the application and to control the output of the advertisement information based on an execution environment of the application, and an output unit to output the advertisement information during execution of the application.

### CROSS-REFERENCE TO RELATED APPLICATION

This application claims priority from and the benefit under 35 U.S.C. §119(a) of Korean Patent Application No. 10-2011-0009384, filed on Jan. 31, 2011, which is incorporated by reference for all purposes as if fully set forth herein.

### BACKGROUND

1. Field

The following description relates to an apparatus and method for providing an application having embedded advertisement information, and more particularly, to an advertisement providing apparatus and method for providing an application between a server which transmits the application and a terminal which receives the application having embedded is advertisement data.

2. Discussion of the Background

As the number of smart phone users has increased, various types of applications mounted on the smart phones have emerged. Accordingly, with the advent of various applications, smart phone applications may include advertisement by displaying advertisement contents on a screen of a smart phone with the applications.

To display an advertisement embedded in an application while executing the application, embedding location of advertisement and advertisement content may be taken into consideration at the application design phase.

Generally, one may sign on to an advertising platform site, download a development tool kit, obtain an application source code, and modify the application source code by adding a code related to advertisement embedding to the application source code.

Accordingly, if an advertisement is embedded into an application using the same advertising platform, the advertisement is outputted with similar position, frequency, content, and the like, regardless of a content of the application.

Further, in order to modify an advertisement embedded in an application, one should obtain the application source code, modify the application source code, and compile the modified application source code again. Accordingly, the above-described method entails inconvenience for advertisement modifiers and increases the time and cost needed to display the application along with various advertisements to application users.

### SUMMARY

Exemplary embodiments of the present invention provide an apparatus and a method for providing an application having embedded advertisement information, including controlling output of the advertisement information based on an execution environment of the application; and outputting the advertisement information during execution of the application. Exemplary embodiments of the present invention also provide a terminal to provide an application having embedded advertisement information.

Additional features of the invention will be set forth in the description which follows, and in part will be apparent from the description, or may be learned by practice of the invention.

Exemplary embodiments of the present invention provide a terminal to provide an application having embedded advertisement information, including a storage unit to store an application and advertisement information added to an execution file of the application; a control unit to execute the application and to control output of the advertisement information based on an execution environment of the application; and an output unit to output the advertisement information during execution of the application.

Exemplary embodiments of the present invention provide an apparatus to provide an application having embedded advertisement information, including a receiving unit to receive an application; an advertisement information generating unit to generate advertisement information based on execution environment information or setting information of the application; a package generating unit to generate a first package, including the application and the advertisement information, by combining the advertisement information with an execution file of the application; and a transmitting unit to transmit the first package to a terminal.

Exemplary embodiments of the present invention provide a method for providing an application having embedded advertisement information, including receiving an application and advertisement information added to an execution file of the application; executing the application; outputting the advertisement information during execution of the application; and controlling the output of the advertisement information based on an execution environment of the application.

Exemplary embodiments of the present invention provide a method for providing an application having embedded advertisement information, including receiving an application; generating advertisement information based on execution environment information or setting information of the application; generating a package, including the application and the advertisement information, by combining the advertisement information with an execution file of the application; and transmitting the package to a terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a terminal to provide an application having embedded advertisement information according to an exemplary embodiment of the present invention.

FIG. 2 is a block diagram illustrating an apparatus to provide an application having embedded advertisement information according to an exemplary embodiment of the present invention.

FIG. 3 is a diagram illustrating a terminal to provide an application having embedded advertisement information and to output differentiated advertisements based on status of the apparatus while executing the application according to an exemplary embodiment of the present invention.

FIG. 4 is a diagram illustrating a terminal to provide an application having embedded advertisement information and to output differentiated advertisements based on executing status of the application according to an exemplary embodiment of the present invention.

FIG. 5 is a flowchart illustrating a communication method according to an exemplary embodiment of the present invention.

FIG. 6 is a flowchart illustrating an operation method for controlling the output of advertisement information according to an exemplary embodiment of the present invention.

FIG. 7 is a flowchart illustrating a communication method according to an exemplary embodiment of the present invention.

FIG. 8 is a block diagram illustrating a portable terminal to provide an application having embedded advertisement information according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which embodiments of the invention are shown. The present disclosure may, however, be embodied in many different forms and should not be construed as limited to the exemplary embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience.

It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the term “and” may be interpreted as “and/or” where enumerated elements or steps may be exclusive or alternatives. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

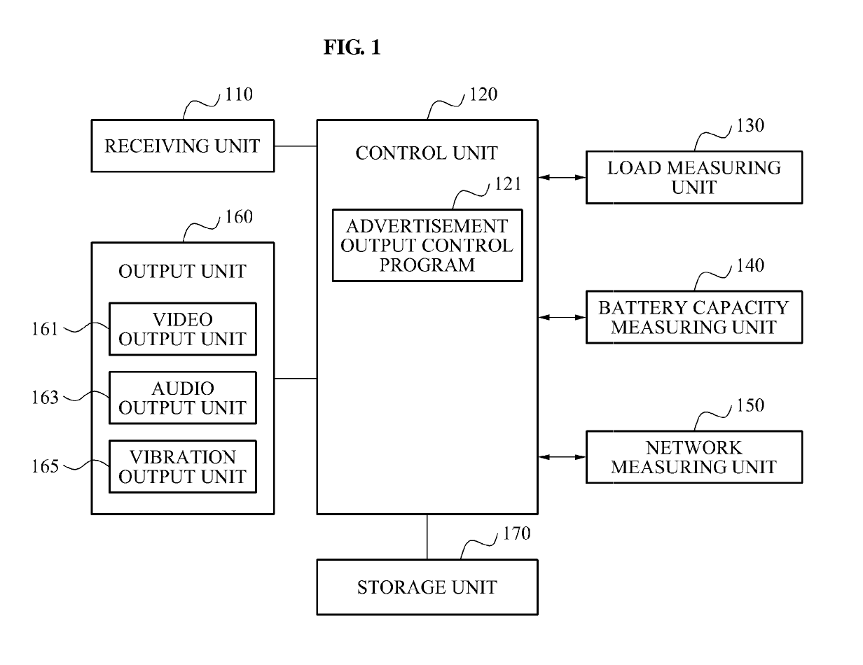

FIG. 1 is a block diagram illustrating a terminal to provide an application having embedded advertisement information according to an exemplary embodiment of the present invention.

As shown in FIG. 1, the terminal includes a receiving unit 110, a control unit 120, a load measuring unit 130, a battery capacity measuring unit 140, a network measuring unit 150, an output unit 160, and a storage unit 170. The control unit 120 may include an advertisement output control program 121, and the output unit 160 may include a video output unit 161, audio output unit 163, and a vibration output unit (tactile output unit) 165. The terminal may include a portable terminal such as a mobile terminal, a PDA, and a tablet computer. The terminal may be included in an apparatus.

The receiving unit 110 may receive an application program (“application”) and advertisement information added to an execution file of the application from an application providing server (not shown in FIG. 1). The application providing server may generate a first package program (“first package”) including an application and advertisement information. The receiving unit 110 may receive the first package including an application and advertisement information. Also, the receiving unit 110 may receive a second package program (“second package”) including an application, advertisement information, and an advertisement output control program. Here, receive may mean download.

The receiving unit 110 may output advertisement information by receiving the second package without downloading an advertisement output control program separately. The advertisement output control program may control the output of advertisement information according to the application.

The second package including an application, advertisement information, and an advertisement output control program, and the first package including an application and advertisement information may be produced by producing advertisement information, modifying the advertisement information into a machine code used in the application, and adding the modified advertisement information to an execution file of the application. In this description, adding may mean embedding.

The advertisement information added to the execution file of the application may include an advertising resource to be outputted while executing the application. The advertising resource may include a content, a display, an audio, a vibration of an advertisement, and the like, that may be outputted by a terminal. Also, the advertisement information may include multiple advertising resources relating to the application.

The advertisement information may include uniform resource locator (URL) information having a link to an advertising resource if the advertising resource is provided through the internet.

The advertisement information may include information about an advertising resource producer. That is, the advertisement information may include origin of the advertisement.

The advertisement information may include version information of an advertisement output control program to control the output of the advertisement information.

The advertisement information may include advertisement setting information including output information of an advertising resource.

The advertisement setting information may include time information to control output timing of an advertising resource, output location information to control output location of an advertising resource, and output type information to control output type of an advertising resource in association with the application execution status. For example, the advertisement setting information may include output start time of an advertising resource and output end time of the advertising resource during execution of an application. Also, the advertisement setting information may include output location of an advertising resource. Also, the advertisement setting information may include whether an advertising resource will be outputted as a video output, an audio output, a vibration output, a tactile output or a combination of those outputs.

Also, the advertisement setting information may include information regarding a type of other application to which an advertising resource may be embedded and outputted. For example, a type of an application related to a content of an advertising resource may be predetermined. In this instance, a keyword may be predetermined and be used to match metadata of an application with an advertising resource.

Also, the advertisement setting information may include information regarding a type of other terminal to which an advertising resource may be outputted. In this instance, an advertising resource may be outputted to a predetermined terminal by limiting types of terminals, or an advertising resource may be outputted to all available terminals in which an application may be executed.

The control unit 120 may execute an application, and may control the output of advertisement information based on an execution environment of the application. While executing an application, the control unit 120 may not output advertisement information in a fixed way, that is, the control unit 120 may output advertisement information in various ways depending on the execution environment of an application.

The execution environment of the application may be an environment based on executing functions reflected on the application. For example, if the application is an application using a gravity sensor, an acceleration sensor, and a gyro sensor, the control unit 120 may output advertisement information using the gravity sensor, the acceleration sensor, and the gyro sensor if the advertisement information is produced to be outputted using the gravity sensor, the acceleration sensor, and the gyro sensor, respectively.

Also, the execution environment of the application may be an environment based on a status of a terminal in which the application is executed. For example, advertisement information may be outputted differently depending on memory and/or battery status of a terminal.

The control unit 120 may control the output of an advertising resource through the advertisement output control program 121. The advertisement output control program 121 may control the output of an advertising resource included in advertisement information.

The advertisement output control program 121 may preset an advertisement type, an output type, a location, a start time, and an end time of an advertising resource output based on the execution environment of an application. Also, the advertisement output control program 121 may be updated periodically or continuously by receiving a new application and a new advertising resource. Also, the advertisement output control program 121 may be updated through downloading from the application providing server. Also, the advertisement output control program 121 may be obtained or updated by receiving a second package including an application, advertisement information, and an advertisement output control program from the application providing server.

In an example, the control unit 120 may identify whether an advertisement output control program 121, controlling the output of an advertising resource included in advertisement information, is installed, and extract version information of the advertisement output control program 121. If the advertisement output control program 121 is not installed in a terminal or the version information of the advertisement output control program 121 is different from the version information included in advertisement information, the control unit 120 may download, from the application providing server, an advertisement output control program 121 having the same version included in advertisement information or may request of may receive the second package including the application output control program 121.

If the control unit 120 executes an application, the control unit 120 may control the output of an advertising resource based on advertisement setting information included in advertisement information. Also, the control unit 120 may control the output of an advertising resource based on advertisement information, specification information of the terminal in which the application is executed, and/or status information of the terminal.

The load measuring unit 130 may measure a load applied to a memory of the terminal in which an application is executed.

The battery capacity measuring unit 140 may measure a remaining battery capacity of the terminal periodically or at a time interval that is programmed or set by a user.

The network measuring unit 150 may measure a type of a communication network and network condition of the communication network to which a terminal is connected. The type of the communication network may include Wireless Fidelity (WiFi), third generation (3G), global positioning system (GPS), long term evolution (LTE), long term evolution-advanced (LTE-A), Bluetooth, wireless broadband internet (WiBro), worldwide interoperability for microwave access (WiMAX), and the like. The network condition of the communication network may be determined as good or bad based on an intensity of a transmitting or receiving signal. In an example, the network condition may be scaled in a numerical range according to the condition. If the intensity of a signal is lower than a first value, the network condition of the communication network may be determined as bad. If the intensity of a signal is higher than a second value, the network condition of the communication network may be determined as good.

The control unit 120 may include configurations of the load measuring unit 130, the battery capacity measuring unit 140, and the network measuring unit 150. Further, the functions performed by the units described above for the terminal are not limited as such, and may be performed in full or in part by one or more other units, including those described above, of the terminal. For example, certain computational-based functions of the load measuring unit 130, the battery capacity measuring unit 140, and the network measuring unit 150 may be performed by the control unit 120.

If a load measured by the load measuring unit 130 exceeds a threshold value, referred to as a threshold memory load, the control unit 120 may control the output of an advertising resource to output an advertising resource having shorter execution time or lower layout capacity compared to other advertising resources among advertising resources included in the advertisement information. Therefore, a load applied to a terminal is reduced if an execution time of an advertising resource is short or a layout capacity of an advertising resource is low.

If the remaining battery capacity measured by the battery capacity measuring unit 140 is less than threshold value, referred to as a threshold battery capacity, the control unit 120 may control the output of an advertising resource to output an advertising resource having short execution time among advertising resources included in advertisement information. Also, the control unit 120 may control the output of an advertising resource to output an advertising resource having lower layout capacity or control the output of an advertising resource without a vibration or an audio output.

The control unit 120 may control the output of an advertising resource, included in advertisement information, based on a type of a communication network determined by the network measuring unit 150. For example, if the determined communication network is WiFi, the control unit 120 may control the output of an advertising resource to output an internet site advertisement or a high-capacity advertising resource. If the determined communication network is Bluetooth, the control unit 120 may control the output of an advertising resource to output a Bluetooth headset advertisement or a low-capacity advertising resource. If the determined communication network is a global positioning system (GPS), the control unit 120 may control the output of an advertising resource to output a GPS-compatible advertisement.

If network condition of the communication network is bad, the control unit 120 may control the output of an advertising resource to output the same advertising resource repeatedly. If network condition of the communication network is good, the control unit 120 may control the output of an advertising resource to output different kinds of advertising resources sequentially.

The control unit 120 may control the output of an advertising resource to output an advertising resource included in advertisement information during loading of an application. The control unit 120 may also control the output of an advertising resource to output an advertising resource during a termination process of an application after finishing execution of the application.

The control unit 120 may control to output an advertising resource included in advertisement information on the output unit 160 of the terminal (a caller's terminal) during an initiation process of an audio or video call through an application, that is, while the caller attempts to initiates an audio or video communication through an application.

The control unit 120 may control to output an advertising resource included in advertisement information on a location of the video output unit 161 on which the execution status of an application is displayed. For example, since the title of an application may be different according to an orientation of the terminal, a selection of a user, or the programming of the application, the control unit 120 may control the output of an advertising resource, at the time the application is executed, to be displayed on a location different than a location where a title of an application is displayed at the time the application is executed.

The control unit 120 may perform a portion of or all the above-described operations performed by the control unit 120 through the advertisement output control program 121.

The output unit 160 may output advertisement information, controlled by the control unit 120 during execution of an application. The output unit 160 may output advertisement information through at least one of the video output unit 161, the audio output unit 163, and the vibration output unit 165 under the control of the control unit 120. For example, advertisement information may be outputted as a video or an audio only. Also, advertisement information may be outputted as a combination of a video, an audio, and a vibration. Throughout the specification, functions of the vibration output unit 165 are not limited to the output of a vibration output. The vibration output unit 165 may output other types of tactile output.

The storage unit 170 may store advertisement information received from the application providing server. The control unit 120 may select advertisement information to be outputted among the advertisement information received by the receiving unit 110 and the advertisement information stored in the storage unit 170, based on the content and the usage type of an application. For example, the control unit 120 may determine advertisement information matched with metadata and a meta-tag of an application as advertisement information to be outputted during execution of the application among the advertisement information received by the receiving unit 110 and the advertisement information stored in the storage unit 170.

Also, if advertising resources, produced by the same producer, are stored in the storage unit 170, the control unit 120 may prioritize advertising resources in a descending order, from an advertising resource which has the highest matching ratio to an advertising resource which has the lowest matching ratio, by matching with metadata and a meta tag of an application among the plurality of advertising resources. The control unit 120 may determine the advertising resources to be outputted among the prioritized advertising resources from an advertising resource which have the highest matching ratio.

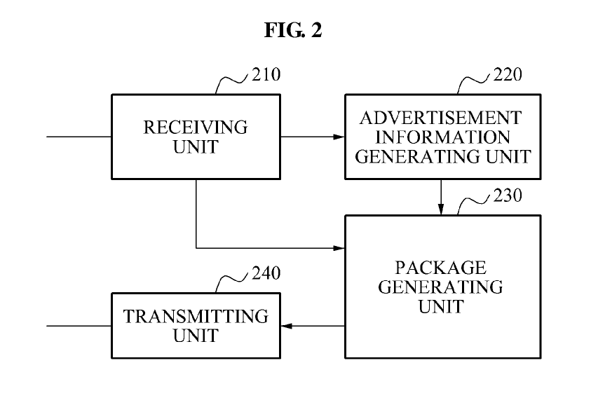

FIG. 2 is a block diagram illustrating an apparatus to provide an application having embedded advertisement information according to an exemplary embodiment of the present invention.

As shown in FIG. 2, the apparatus includes a receiving unit 210, an advertisement information generating unit 220, a package generating unit 230, and a transmitting unit 240. The apparatus may be included in or may communicate with an application providing server.

The receiving unit 210 may receive an application. The receiving unit 210 may receive an application to perform a predetermined function from a user, or the receiving unit 210 may receive an application from other application providing servers. Further, the receiving unit 210 may receive raw advertisement data. In an example, the received raw advertisement data may include an advertising resource to be outputted while an application is executed, URL information having a link of an advertising resource if the advertising resource is provided through the internet, information about an advertising resource producer, version information of an advertisement output control program to control the output of advertisement information, and the like.

The advertisement information generating unit 220 may generate advertisement information based on execution environment information or setting information of an application. Specifically, the advertisement information generating unit 220 may generate advertisement information by modifying raw advertisement data to be matched with execution environment information or setting information of an application. The execution environment information of an application may include a type of a terminal in which the application is executable, a type of a network to which the terminal is connectable, capacities of a memory and a battery applicable to the terminal, and the like. The setting information of an application may include resolution information, size information, and an operating function of the application.

The advertisement information generating unit 220 may generate advertisement setting information related to the output of an advertising resource based on execution environment information of an application. The advertisement information may be made of a machine code based on the execution file of targeted application.

The advertisement setting information may include information about a time when an advertising resource is to be outputted, information about an output location at which an advertising resource is to be outputted, and information about an output type of an advertising resource such as video, audio, and vibration.

For example, the advertisement information generating unit 220 may determine a start time of an output of an advertising resource and an end time of the output of the advertising resource during execution of an application based on a type of a terminal, and memory capacity and battery capacity of the terminal. Also, the advertisement information generating unit 220 may determine an output location of an advertising resource on a display based on variable locations of titles or variable locations of texts of an application on the display over time. Also, the advertisement information generating unit 220 may determine output type. In an example, the advertisement information generating unit 220 may determine whether an advertising resource is to be outputted as a video only, a combination of a video and an audio, or a combination of a video, an audio, and a vibration.

The advertisement information generating unit 220 may modify an advertising resource to be matched with an application based on metadata of the application. Further, the advertisement information generating unit 220 may modify an advertising resource based on resolution information and size information of the application.

The advertisement information generating unit 220 may generate advertisement setting information including information about a type of other terminal to which an advertising resource can be outputted. In this instance, the advertisement information generating unit 220 may generate setting information including limitation setting to limit output of an advertising resource to only a predetermined terminal by controlling the limitation setting. The advertisement information generating unit 220 may generate setting information that an advertising resource may be outputted to all available terminals to which an application can be executed by controlling the limitation setting.

The advertisement information generating unit 220 may generate advertisement information with reference to metadata included in an application. The advertisement information generating unit 220 may generate advertisement information by modifying raw advertisement data received by the receiving unit 210 according to the metadata of the application.

The advertisement information generating unit 220 may generate advertisement information based on a function of a terminal utilized during an execution of an application, so that the function of the terminal may be reflected on the execution of the advertisement information or the function of the terminal may be utilized on conveying the advertisement information. For example, if a function of the application requires a utilization of a gravity sensor, an acceleration sensor, and a gyro sensor, the advertisement information generating unit 220 may generate advertisement information using functions of the gravity sensor, the acceleration sensor, and the gyro sensor so that the advertisement information may be conveyed through the utilization of the gravity sensor, the acceleration sensor, and the gyro sensor, respectively.

The package generating unit 230 may generate a first package, including an application and advertisement information, by combining the advertisement information with an executable file of the application. Further, the package generating unit 230 may generate a second package, including an application, advertisement information, and an advertisement output control program, by combining the advertisement information with an executable file of the application and the advertisement output control program.

The package generating unit 230 may generate the first package or the second package by modifying the advertisement information into a machine code based on a format of a source code of the application and by adding the advertisement information to the application. That is, the advertisement information is modified into executable code-based advertisement information.

For example, in an android-based application, the package generating unit 230 may generate Advertisement Activity (“Ad Activity”) for advertisement information. The package generating unit 230 may add advertisement information to an application by extracting an ‘AndroidMainfest.xml’ file from the application and by adding the generated Ad Activity to the extracted file.

The package generating unit 230 may generate a package including the first package and/or the second package by extracting an execution file of an application and by adding executable code-based advertisement information to the extracted execution file. The transmitting unit 240 may transmit the package, generated by the package generating unit 230, to a terminal.

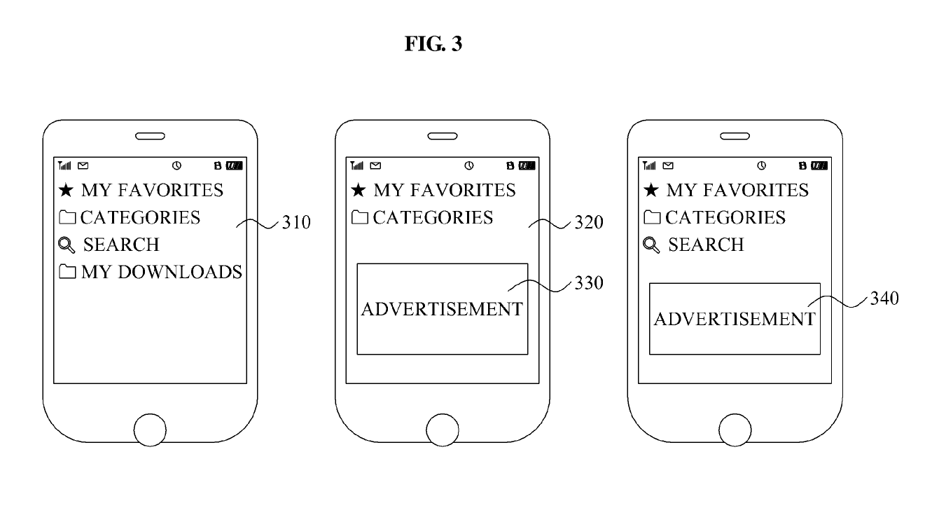

FIG. 3 is a diagram illustrating a terminal to provide an application having embedded advertisement information and to output differentiated advertisements based on status of the apparatus while executing the application according to an exemplary embodiment of the present invention.

Referring to FIG. 3, if an application is being executed in a terminal, an execution status of an application 310 may be outputted on a display of the terminal.

For displaying new advertisement information during the execution of an application after completing the generation of an execution file of the application, the new advertisement information, which is executable code-based, may be added into the execution file of the application. The new advertisement information may be displayed on a location 330 of a display 320 on which the application execution status is displayed. Thus, even if advertisement arrangement scheme is not considered in an application design phase, new advertisement information is able to be directly added to the execution file of the application after completing the development of the application without modifying the source code of the application and recompiling the modified source code of the application.

Further, display location of and size of advertisement information may be changed based on the execution status of an application. In an example, output of advertisement information 330 is changed into smaller advertisement information 340, as shown in FIG. 3 according to the execution status information of an application. Three different execution status information displays of an application are shown in FIG. 3. Also, output of advertisement information may be changed based on status information of a terminal. For example, if memory load of a terminal is high, the execution of advertisement information, having long execution time or high data capacity, may cause frequent delays of an execution of an application. Thus, if memory load of a terminal exceeds threshold memory load, embedded advertisement information having a data capacity that is larger than threshold data capacity may not be outputted or may be replaced with advertisement information having a data capacity that is less than the threshold data capacity. Accordingly, advertisement information, having a relatively short execution time advertisement or low data capacity, may be outputted on the display 320 along with execution status information of an application if the memory load exceeds the threshold memory load. Further, if the remaining battery capacity of a battery mounted in a terminal is less than threshold battery capacity, advertisement information, having relatively short execution time or low data capacity, may be outputted on a display 320 along with execution status information of an application. In an example, advertisement information of which data capacity is larger than threshold data capacity may not be outputted on the display.

Further, advertisement information related to a content of an application may be selected based on the content of an application and be outputted on a display. For example, if an application is related to weather information, a site related to weather information or weather-related advertisement information may be outputted on a display of a terminal.

Further, certain types of advertisement information may be outputted based on information of a communication network to which a terminal is connected, or advertisement information may be outputted in certain types of formats based on information of a communication network to which a terminal is connected. For example, if a communication network to which a terminal is connected is WiFi, advertisement information about a WiFi enabled router product or area information where WiFi is available may be outputted as advertisement information. If a communication network to which a terminal is connected is Bluetooth, low data capacity advertisement information or Bluetooth related advertisement information may be outputted. The characteristic information of the communication network such as bandwidth, data-rate, and viable communication distance may be considered to select proper advertisement information to be outputted. If the communication network, such as Bluetooth, does not support high data-rate, only low data capacity advertisement information may be outputted.

Update information for an item among configurations of a terminal may be outputted as advertisement information if update resource is available for the item. For example, if currently usable font for a terminal is an android font, update information of an additional usable font may be outputted as advertisement information. Further, information related to a terminal manufacturer and an application developer may be outputted as advertisement information.

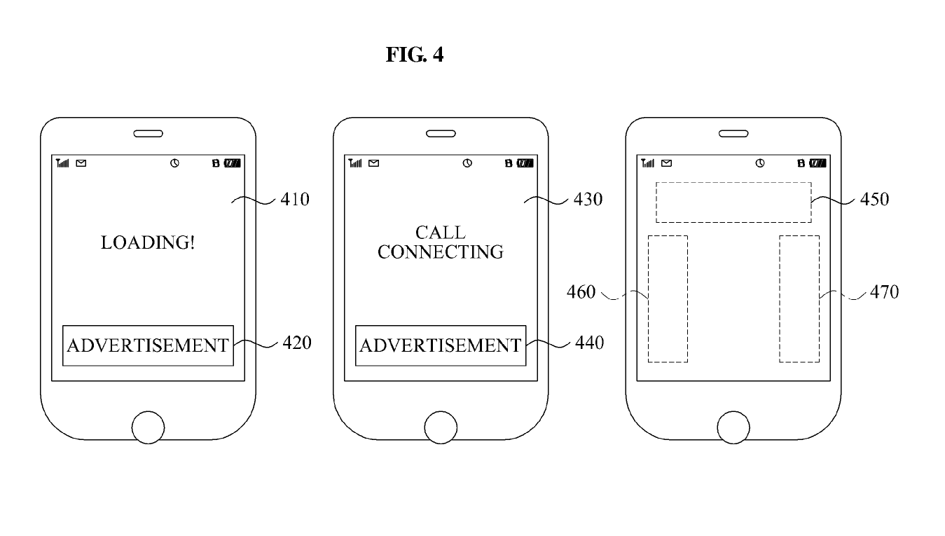

FIG. 4 is a diagram illustrating a terminal to provide an application having embedded advertisement information and to output differentiated advertisements based on executing status of the application according to an exemplary embodiment of the present invention.

Referring to FIG. 4, while loading an application 410 for execution of the application, advertisement information 420 may be outputted. The output of the advertisement information 420 may be determined based on loading rate and loading time of the application, so that an advertisement may be fully displayed to a user while loading an application. The advertisement setting information may include advertisement information matched with the loading rate and the loading time of each application. Also, the advertisement setting information may include advertisement quality setting information capable of controlling variable data capacity and resolution for the same advertisement information.

Advertisement information may be outputted during a termination process of the application after finishing execution of the application until complete termination of the application.

Further, advertisement information 440 may be outputted while a user attempts to initiate an audio or video call 430 through a terminal. If a user attempts to initiate an audio or video call using an application related to a voice over internet protocol (VoIP), advertisement information may be outputted in a video or an audio format.

Further, advertisement information may be outputted on predetermined locations 450, 460, and 470 of a display to which execution status information of an application is outputted during execution of the application. In this instance, the advertisement information may be generated to be differentiated from a text, an image, and a picture of the execution status information outputted during execution of an application. Also, advertisement information may be outputted on predetermined areas 450, 460, and 470 to be differentiated from the location of a display on which the execution status information of an application is displayed.

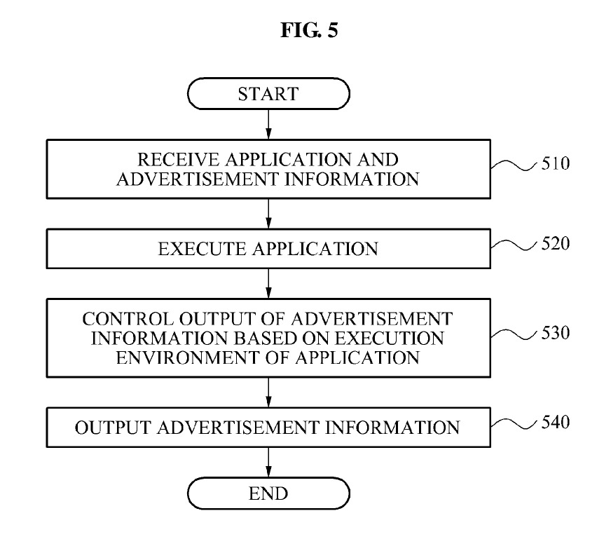

FIG. 5 is a flowchart illustrating a communication method according to an exemplary embodiment of the present invention.

In operation 510, a terminal receives an application and advertisement information added to an execution file of the application from an application providing server. Alternatively, the terminal may receive a second package including an application, advertisement information, and an advertisement output control program.

The application providing server may generate a first package including an application and advertisement information. Alternatively, the application providing server may generate a second package including an application, advertisement information, and an advertisement output control program. The first and the second packages may be generated by modifying advertisement information into machine code-based advertisement information and by adding the modified advertisement information to an execution file of the application. The machine code-based advertisement information may be a machine code used in the application.

In this instance, the advertisement information added to the execution file of the application may include an advertising resource to be outputted during an execution of the application. The advertising resource may include a content, a display, an audio, a vibration of an advertisement, and the like, that may be outputted to a terminal.

In operation 520, the terminal executes the application.

In operation 530, the terminal controls the output of the advertisement information based on an execution environment of the application. The execution environment of the application may be available functions reflected on the application. For example, if the application is using a gravity sensor, an acceleration sensor, and a gyro sensor as its functions, the terminal may output the advertisement information using the gravity sensor, the acceleration sensor, and the gyro sensor where the advertisement information is generated to utilize the gravity sensor, the acceleration sensor, and the gyro sensor, respectively.

The execution environment of the application may be a status of the terminal in which the application is executed. For example, the advertisement information may be outputted differently depending on memory and battery status of the terminal.

While the terminal is executing the application, the terminal may control the output of the advertising resource based on advertisement setting information included in the advertisement information. Also, the terminal may control the output of the advertising resource based on the advertisement information, specification information of the terminal, and status information of the terminal.

In operation 540, the terminal outputs the advertisement information during execution of the application. The terminal may output the advertisement information using at least one media selected from the group consisting of a video, an audio, and a vibration.

Also, the terminal may store the advertisement information received from the application providing server, and may determine advertisement information to be outputted among the received advertisement information and the stored advertisement information based on the content and the usage type of the application.

For example, the terminal may determine advertisement information, matched with metadata and a meta-tag of the application, as advertisement information to be outputted among the advertisement information received from the application providing server and the advertisement information stored in the storage unit 170.

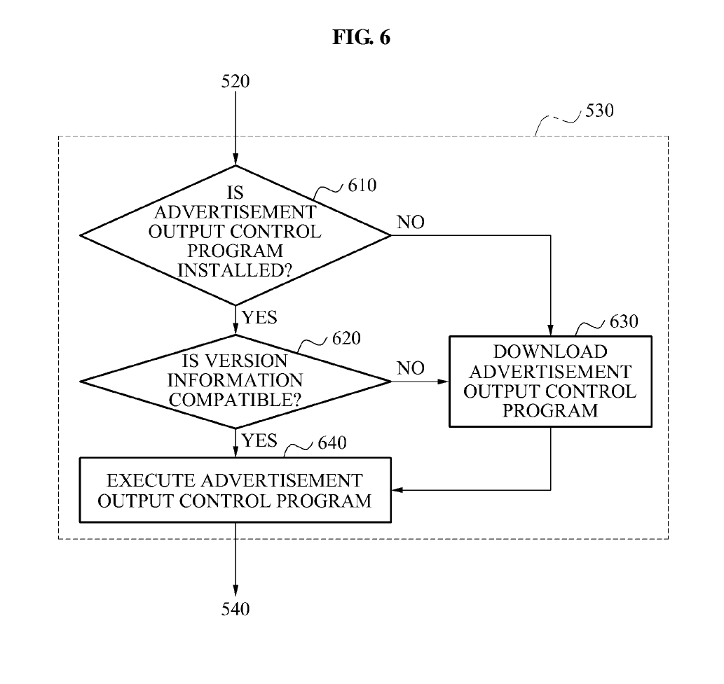

FIG. 6 is a flowchart illustrating an operation method for controlling the output of advertisement information according to an exemplary embodiment of the present invention.

In operation 610, the terminal determines whether an advertisement output control program is installed in the terminal. The advertisement output control program may control the output of the advertising resource included in the advertisement information. The terminal may control the output of the advertising resource by executing the advertisement output control program.

In operation 620, the terminal extracts version information of the advertisement output control program if it is determined that an advertisement output control program is installed in the terminal. The determination of whether advertising resource can be output is determined based on the version of the advertisement output control program. Also, the terminal may control the output of the advertising resource included in the advertisement information only if the version information of an advertisement output control program included in the advertisement information is equal to the version information of an advertisement output control program installed in the terminal.

In operation 630, the terminal downloads the version of an advertisement output control program that is included in the advertisement information from the application providing server, if the advertisement output control program is not installed in the terminal or the version information of the advertisement output control program included in the advertisement information is different from the version information of the advertisement output control program installed in the terminal.

In operation 640, the terminal controls the output of the advertising resource included in the advertisement information by executing the advertisement output control program if the version information of the advertisement output control program included in the advertisement information is compatible with the version information of the advertisement output control program installed in the terminal. The advertisement output control program may preset a type, an output type, a location, a start time, and an end time of the advertising resource to be outputted based on the execution environment of the application.

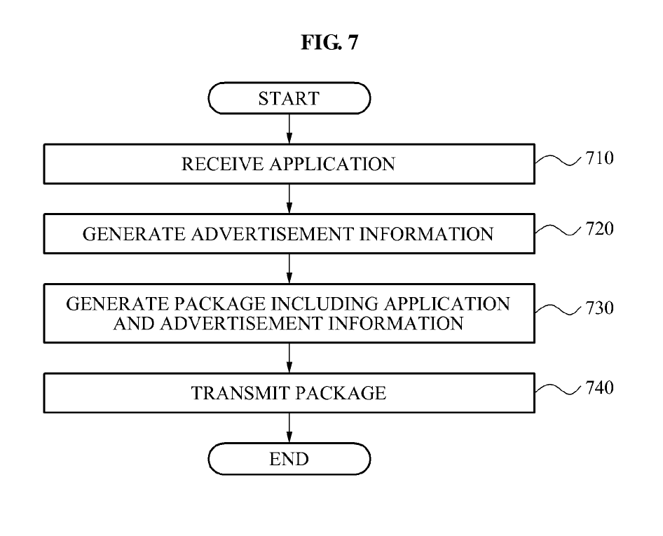

FIG. 7 is a flowchart illustrating a communication method according to an exemplary embodiment of the present invention.

In operation 710, an apparatus such as an application providing server may receive an application. The apparatus may receive an application from a user. Also, the apparatus may receive an application from other application providing servers. Also, the apparatus may receive raw advertisement data.

In operation 720, the apparatus may generate advertisement information based on execution environment information or setting information of the application. The execution environment information of the application may include information such as a type of a terminal in which the application is executable, a type of a network to which the terminal is connectable, and capacities of a memory and a battery of the terminal. The setting information of the application may include resolution information, size information, and an operating function of the application. The apparatus may generate advertisement information by modifying the raw advertisement data to be matched with the execution environment information or setting information of the application.

The apparatus may generate advertisement information by referring to metadata included in the application. For example, the apparatus may generate advertisement information based on the resolution information and the size information of the application.

In operation 730, the apparatus generates a first package, including the application and the advertisement information, by combining the advertisement information with an execution file of the application. Also, the apparatus may generate a second package, including the application, the advertisement information, and an advertisement output control program, by combining the advertisement information with an execution file of the application and the advertisement output control program.

The apparatus may generate a first package, including the application and the advertisement information, by modifying the advertisement information into a machine code based on a format of a source code of the application and by adding the advertisement information to the application. That is, the apparatus may generate the first package by extracting an execution file of the application and by adding the modified advertisement information to the extracted execution file. Also, the apparatus may generate a second package, including the application, the advertisement information, and the advertisement output control program, by adding the advertisement output control program to the second package including the application and the advertisement information.

In operation 740, the apparatus transmits the first package and/or the second package to the terminal.

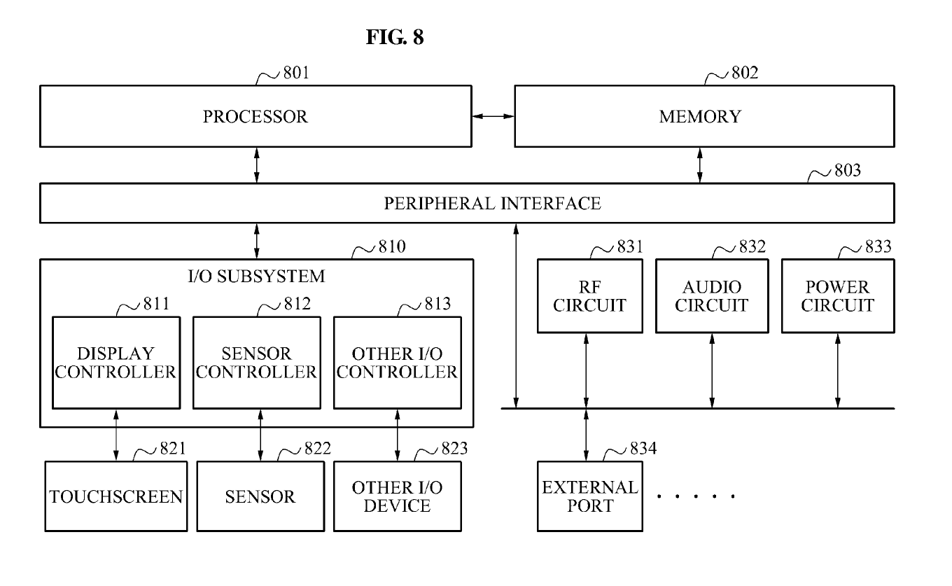

FIG. 8 is a block diagram illustrating a portable terminal to provide an application having embedded advertisement information according to an exemplary embodiment of the present invention.

A portable terminal 800 may include a processor 801, a memory 802, a peripheral interface 803, an input/output (I/O) subsystem 810, a touch screen 821, a sensor 822, an other I/O device 823, a radio frequency (RF) circuit 831, an audio circuit 832, a power circuit 833, and an external port 834. These components may communicate with each other through at least one communication bus or signal line.

The portable terminal 800 may include more or less components, a combination of at least two components, or a configuration or an arrangement including different components. The components of FIG. 8 may be incorporated into hardware including an integrated circuit for signal processing or application operation, or into a combination of a hardware and a software.

The memory 802 may include a high-speed random access memory, a magnetic disk, a static random access memory (SRAM), a dynamic RAM (DRAM), read-only memory (ROM), a flash memory, or a non-volatile memory. The memory 802 may include a software module, an instruction set, or other various data required for operation of the portable terminal 800. An access to the memory 802 by other components such as the processor 801 and the peripheral interface 803 may be controlled by the processor 801.

The peripheral interface 803 may connect an input and/or output peripheral device of the portable terminal 800 with the processor 801 and the memory 802. The processor 801 may perform various functions for the portable terminal 800 and may process data by executing a software module or an instruction set stored in the memory 802.

The RF circuit 831 may transmit and receive an RF signal (also referred to as an electromagnetic signal). The RF circuit 831 may convert an electrical signal into an electromagnetic signal or vice versa, and may transceive with a communication network and an apparatus to provide an application having embedded advertisement information using the electromagnetic signal.

The RF circuit 831 may include a circuit to perform these functions, and such a circuit may include, although not shown, an antenna system, an RF transceiver, at least one amplifier, a tuner, at least one oscillator, a digital signal processor, a codec chipset, a subscriber identity module (SIM) card, a memory, and the like. However the RF circuit 831 is not limited as such.

The RF circuit 831 may communicate with a wireless network including a cellular phone network, a wireless local area network (WLAN), and/or a metropolitan area network (MAN), an intranet, and/or a network such as Internet also referred to as world wide web (WWW), and with other devices, via wireless communications.

The wireless communication may include protocols for communications such as global system for mobile communications (GSM), enhanced data GSM environment (EDGE), wideband code division multiple access (W-CDMA), code division multiple access (CDMA), time division multiple access (TDMA), Bluetooth, Wi-Fi (in accordance with IEEE 802.11a, IEEE 802.11b, IEEE 802.11g, and/or IEEE802.11n), VoIP, Wi-MAX, LTE, internet message access protocol (IMAP), and/or post office protocol (POP), protocols for instant messaging such as eXtensible messaging and presence protocol (XMPP), session initiation protocol for instant messaging and presence leveraging extensions (SIMPLE) instant messaging and presence service (IMPS), or short message service (SMS), or other communication protocols.

Also, the above-described wireless communication may use a plurality of communication protocols, protocols, and techniques not limited in this regard.

The audio circuit 832 may provide an audio interface between a user and the portable terminal 800 using a speaker and/or a microphone (not shown). The audio circuit 832 may receive audio data from the peripheral interface 803, may convert the audio data into an electrical signal, and may transmit the electrical signal to the speaker. The speaker may convert the electrical signal into a human-audible sound wave.

Also, the audio circuit 832 may receive an electrical signal converted from a sound wave by a microphone (not shown). The audio circuit 832 may convert an electrical signal into audio data, and transmit the audio data to the peripheral interface 803 for processing. The audio data may be retrieved from or transmitted to the memory 802 or the RF circuit 831 by the peripheral interface 803.

Further, the audio circuit 832 may include a headset jack (not shown). The headset jack may provide an interface between the audio circuit 832 and a portable audio I/O peripheral device such as a headset for both input and output or a headphone for output only.

The power circuit 833 may provide power to a portion of or all of the components of the portable terminal 800. For example, the power circuit 833 may include a power management system, at least one power source such as a battery or an alternate current (AC), a charger system, a power failure detection circuit, a power converter or an inverter, a power status indicator, and another component used for generation, management and distribution of power of the portable terminal 800.

The I/O subsystem 810 may connect an I/O peripheral device such as the touch screen 821, the sensor 822, or the other I/O device 823 to the peripheral interface 803. The I/O subsystem 810 may include a display controller 811, a sensor controller 812, or at least one other I/O controller 813. Alternatively, the touch screen 821, the sensor 822, or the other I/O device 823 may be connected to the peripheral interface 803 without the I/O subsystem 810.

In an example, the processor 801, the peripheral interface 803, and the I/O subsystem 810 may be embodied in a single chip. Alternatively, a portion of the processor 801, the peripheral interface 803, and the I/O subsystem 810 may be embodied in a single chip.

The display controller 811 may receive an electrical signal from the touch screen 821 having a touch sensitive area, may transmit an electrical signal to the touch screen 821, or may transmit and receive an electrical signal to and from the touch screen 821. The touch screen 821 may display a visual output to a user by the control of the display controller 811. The visual output may include a graphic, a text, an icon, a video, or any combination thereof (hereinafter collectively referred to as a “graphic”). According to an aspect, the entirety or a portion of the visual output may correspond to a user interface described in more detail below.

The touch screen 821 may use a liquid crystal display (LCD), light emitting polymer display (LPD), organic light-emitting diode (OLED), or active-matrix organic light-emitting diode (AMOLED) technology, however other display technologies may be used. Also, the touch screen 821 and the display controller 811 may use a capacitive technology, a resistive technology, an infrared technology, or a surface acoustic wave technology, however the present invention is not limited in this regard. Another technology of touch sensing technologies may be used. Also, the touch screen 812 and the display controller 856 may sense a contact or an arbitrary movement or release of the contact using a proximity sensor array or other components for determining at least one contact point on the touch screen 821.

The display controller 811 may be combined with a screen not having a touch sensing area. The screen not having a touch sensing area may receive an electrical signal from the display controller 811 and may display a visual output to a user.

The screen not having a touch sensing area may use a plasma display panel (PDP), electronic paper display (EPD), LCD, LPD, OLED, or AMOLED technology, however other display technologies may be used.

The portable terminal 800 having the screen not having a touch sensing area may provide an I/O device as a user interface for an operation, such as a physical keyboard, a mouse, a physical button, and the like.

At least one other I/O controller 813 may receive an electrical signal from the other I/O device 823 or may transmit an electrical signal to the other I/O device 823. The other I/O device 823 may include, for example, a keyboard, a touch pad, a dial, a slider switch, a joystick, and the like. Also, the other I/O controller 813 may be combined with a device among an infrared port, a universal serial bus (USB) port, a pointer device such as a mouse, and the like.

In an example, the other I/O device 823 may include at least one physical button or virtual button. If the other I/O device 823 is a virtual button, a button and a button controller may be a portion of the touch screen 821 and a portion of the display controller 811, respectively.

In an example, the button may include an up/down button for volume control of the speaker or the microphone, a locker button, or a push button. For example, if a user presses a push button for a short-time, a locked state of the touch screen 821 may be released into unlocked state, and if a gesture is applied to the touch screen 821 after unlocking the touch screen 821, a locked state of the device 800 may be released into unlocked state.

Also, a user may press the push button for a long-time to turn on or turn off a power source of the portable terminal 800.

In an example, the other I/O device 823 may include at least one physical keyboard or virtual keyboard. For example, the keyboard may use symbols of a standard layout (QWERTY) and/or a non-standard layout. A soft keyboard and a soft keyboard controller of the virtual keyboard may be a portion of the touch screen 821 and a portion of the display controller 811, respectively.

An example of the soft keyboard may include a larger or smaller number of graphics or soft keys than a physical keyboard. Accordingly, a user may select at least one graphic of a soft keyboard, and may display at least one corresponding symbol on the touch screen 821.

The other I/O device 823 may include a touch pad for activating or deactivating a predetermined function. In an example, the touch pad may have a touch sensing area not display a visual output, unlike the touch screen 821.

Also, the touchpad may be a touch sensing surface separated from the touch screen 821 or a portion of an expanded touch sensing surface formed by the touch screen 821.

The above-described methods according to the exemplary embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media (such as hard disks, floppy disks, and magnetic tape), optical media (such as CD ROM discs and DVDs), magneto-optical media (such as optical discs), and hardware devices that are specially configured to store and perform program instructions, such as ROM, RAM, flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments.

The above-mentioned exemplary embodiments may enable embedding advertisement information directly into an execution file of an application, thereby eliminating modification of a source code of the application and compile of the modified source code. The above-mentioned exemplary embodiments may also enable outputting differentiated advertisement information depending on content of an application, thereby aligning the content of the application and the content of the advertisement information. The above-mentioned exemplary embodiments may also enable outputting differentiated advertisement information based on the status of a terminal, thereby delivering advertisement information without causing overload of the terminal.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal to provide an application having embedded advertisement information, comprising:
a storage unit to store an application and advertisement information added to an execution file of the application;
a control unit to execute the application and to control output of the advertisement information based on an execution environment of the application; and
an output unit to output the advertisement information during execution of the application.

2. The terminal of claim 1, further comprising:
a receiving unit to receive a package comprising the application and the advertisement information from an application providing server.

3. The terminal of claim 2, wherein the package further comprises an advertisement output control program, the advertisement output control program to control the output of the advertisement information related to the application, and
the control unit controls the output of the advertisement information based on content of the application or usage type of the application.

4. The terminal of claim 1, wherein the advertisement information comprises an advertising resource, uniform resource locator (URL) information, information about an advertising resource producer, advertisement setting information, or version information of the advertisement output control program.

5. The terminal of claim 4, wherein the advertisement setting information comprises information about a time when the advertising resource is to be outputted, information about a location where the advertising resource is to be outputted, information about a type of other application to which the advertising resource is executable, or information about an output type of the advertising resource.

6. The terminal of claim 1, wherein the control unit modifies raw advertisement data into a machine code, and adds the modified advertisement information to the execution file of the application, and
the storage unit further stores the modified advertisement information.

7. The terminal of claim 1, wherein the control unit determines whether an advertisement output control program is installed in the terminal, compares version information of the advertisement output control program with version information of the advertisement information if the advertisement output control program is installed, and downloads an advertisement output control program having the same version information included in the advertisement information.

8. The terminal of claim 7, wherein the control unit controls output of an advertising resource included in the advertisement information by executing the advertisement output control program.

9. The terminal of claim 4, wherein the control unit controls output of the advertising resource based on the advertisement setting information, or
the control unit controls output of the advertising resource based on at least one of the advertisement information, specification information of the terminal, and status information of the terminal.

10. The terminal of claim 1, further comprising:
a load measuring unit to measure memory load of a memory included in the terminal;
a battery capacity measuring unit to measure remaining battery capacity of the terminal; and
a network measuring unit to determine a type of communication network to which the terminal is connected, and to measure network condition of the connected communication network.

11. The terminal of claim 10, wherein the control unit controls to output an advertising resource having a shorter execution time than a threshold execution time or to output an advertising resource having lower data capacity than a threshold data capacity among advertising resources included in the advertisement information if the memory load exceeds threshold memory load or if the remaining battery capacity is less than threshold battery capacity.

12. The terminal of claim 10, wherein the control unit controls to output an advertising resource having a lower layout capacity than threshold layout capacity, or to output an advertising resource not having a vibration or an audio among the advertising resources included in the advertisement information if the remaining battery capacity is less than threshold battery capacity.

13. The terminal of claim 10, wherein the control unit controls the output of the advertising resource included in the advertisement information based on characteristic information of the connected communication network.

14. The terminal of claim 1, wherein the control unit controls output of an advertising resource included in the advertisement information during loading of the application, or controls output of the advertising resource during a termination process of the application after finishing execution of the application.

15. The terminal of claim 1, wherein the control unit controls output of an advertising resource included in the advertisement information on the output unit during an initiation process of an audio call or video call.

16. The terminal of claim 1, wherein the control unit controls to output an advertising resource included in the advertisement information on a first location of a display differentiated from a second location of the display on which application execution status is displayed.

17. An apparatus to provide an application having embedded advertisement information, comprising:
a receiving unit to receive an application;
an advertisement information generating unit to generate advertisement information based on execution environment information or setting information of the application;
a package generating unit to generate a first package, comprising the application and the advertisement information, by combining the advertisement information with an execution file of the application; and
a transmitting unit to transmit the first package to a terminal.

18. The apparatus of claim 17, wherein the advertisement information generating unit generates the advertisement information with reference to metadata included in the application.

19. The apparatus of claim 17, wherein the advertisement information generating unit generates the advertisement information based on a function of the terminal to reflect the function of the terminal on the execution of the advertisement information.

20. The apparatus of claim 17, wherein the advertisement information comprises an advertising resource, URL information having a link of an advertising resource, information about an advertising resource producer, advertisement setting information, or version information of an advertisement output control program.

21. The apparatus of claim 17, wherein the first package further comprises an advertisement output control program.

22. The apparatus of claim 17, wherein the package generating unit generates the first package by extracting the execution file of the application and by adding the advertisement information to the execution file, and
the advertisement information comprises a machine code corresponding to a type of machine code of the execution file.

23. A method for providing an application having embedded advertisement information, comprising:
receiving an application and advertisement information added to an execution file of the application;
executing the application;
outputting the advertisement information during execution of the application; and
controlling the output of the advertisement information based on an execution environment of the application.

24. The method of claim 23, further comprising receiving an advertisement output control program,
Wherein the advertisement output control program controls the output of the advertisement information according to the application.

25. The method of claim 23, further comprising:
storing the advertisement information; and
selecting advertisement information among received advertisement information and stored advertisement information based on content and usage type of the application.

26. The method of claim 23, further comprising:
determining whether an advertisement output control program is installed; and
comparing version information of the advertisement output control program with version information of the advertisement information if the advertisement output control program is installed,
wherein the advertisement output control program controls the output of the advertising resource included in the advertisement information if the version information of the advertisement output control program is compatible with the version information included in the advertisement information.

27. The method of claim 26, wherein controlling the output of the advertisement information further comprises controlling the output of the advertising resource based on advertisement setting information included in the advertisement information, or
controlling the output of the advertising resource based on at least one of the advertisement information, specification information of a terminal in which the application is executed, and status information of the terminal.

28. A method for providing an application having embedded advertisement information, comprising:
receiving an application;
generating advertisement information based on execution environment information or setting information of the application;
generating a package, comprising the application and the advertisement information, by combining the advertisement information with an execution file of the application; and
transmitting the package to a terminal.

29. The method of claim 28, wherein the generating of the advertisement information comprises generating the advertisement information with reference to metadata included in the application.

30. The method of claim 28, wherein generating the package further comprises generating the package, comprising the application, the advertisement information, and an advertisement output control program, by combining the advertisement information with an execution file of the application and the advertisement output control program.

31. The method of claim 28, wherein generating the package further comprises generating the package by extracting the execution file of the application and by adding the advertisement information to the execution file.
